(19) United States
(12) Patent Application Publication
(10) Pub. No.: US 2005/0162557 A1
(43) Pub. Date: Jul. 28, 2005

(54) Method and apparatus for controlling display of digital television capable of implementing various screen displays

(75) Inventor: Byung-Tae Choi, Anyang-city (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/042,081

(22) Filed: Jan. 26, 2005

(30) Foreign Application Priority Data
Jan. 27, 2004 (KR) 2004-5130

(51) Int. Cl. H04N 5/45

(52) U.S. Cl. 348/565

(57) ABSTRACT

Disclosed herein is a method and apparatus for controlling the display of a digital television capable of implementing various screen displays. In accordance with a first aspect of the present invention, there is provided a method of controlling a display of a digital television, wherein a single alpha value is assigned to each of pixels constituting a Picture-In-Picture (PIP) screen, so that the single alpha value is set to a desired value, thus adjusting a blending level of the PIP screen and displaying the blending level-adjusted PIP screen. In accordance with a second aspect of the present invention there is provided a method of controlling a display of a digital television, wherein a PIP screen is divided into sections each having pixels, the number of which corresponds to a W×H pixel size, and a predetermined bit value assigned to each pixel is adjusted, thus implementing a PIP screen having a desired shape.

### BACKGROUND OF THE INVENTION

1. Field of the Invention

The present invention relates, in general, to a method and apparatus for controlling the display of a digital television and, more particularly, to a method and apparatus for controlling the display of a digital television, which can arbitrarily adjust the display shape of a screen and a blending level using a single alpha value or an alpha map in the digital television, thus configuring visually effective screens.

2. Description of the Related Art

Recently, digital televisions (TVs) have rapidly propagated into homes. Most digital TVs have the function of displaying a plurality of pictures, such as a Picture-In-Picture (PIP) function, therein. PIP is the function of simultaneously displaying a main picture and a small sub-picture on the same screen of a TV monitor. This function is similar to that of windows of a Personal Computer (PC), and is called a PIP function. In a TV having the PIP function, a picture forming a background is called a main screen and a picture displayed at a small size is called a PIP screen. If this function is used, a user can simultaneously watch the contents of another channel while watching a program on a specific channel, but there is a disadvantage in that part of the screen is hidden. A screen on which a normal broadcast picture having an aspect ratio of 4:3 is displayed on a portion of an entire screen of a wide TV (having an aspect ratio of 16:9) is a kind of PIP screen.

FIG. 1 is a block diagram of a conventional apparatus for generating a PIP screen, which includes a main scaler 101, a PIP scaler 102 and a screen mixer 103.

In the apparatus of FIG. 1, two screens overlap each other in an area where a main screen and a PIP screen coexist. In the conventional apparatus, where the two screens overlap each other, only a rectangular PIP screen is displayed.

Further, in a conventional digital TV, when a PIP screen is configured, 1 bit is used as a single alpha value, so that a control operation is performed only by switching two screens on or off. That is, the alpha value generally indicates opacity. If the alpha value of a PIP screen is 1, the PIP screen is displayed in a fully opaque state, while if the alpha value is 0, the PIP screen is fully transparent, and only a background screen is displayed. Therefore, the alpha value has been used to switch between two screens.

The above-described method is also equally applied to the configuration of screens employing other schemes, such as Picture-Out-of-Picture (POP) function. PIP and POP can be understood in such a way that PIP is a method of simultaneously displaying one or more screens or channels and is generally implemented to have one or more pictures in a large screen, while POP is a method of simultaneously displaying a plurality of screens without small pictures.

These screen configurations are limited in that only a rectangular PIP screen and a background screen may be selectively displayed at the time of configuring a plurality of screens, and, in addition, a function of changing a blending effect and a display shape for each screen cannot be provided, so that a variety of screen effects cannot be created.

### SUMMARY OF THE INVENTION

Accordingly, the present invention has been made keeping in mind the above problems occurring in the prior art, and an object of the present invention is to provide a method and apparatus for controlling the display of a digital television, which can arbitrarily adjust the display shape of an output screen and a blending level using a single alpha value or an alpha map in the digital television, thus configuring visually effective screen displays.

In order to accomplish the above object, the present invention provides a method of controlling a display of a digital television, wherein a single alpha value is assigned to each of pixels constituting a Picture-In-Picture (PIP) screen, so that the single alpha value is set to a desired value, thus adjusting a blending level of the PIP screen and displaying the blending level-adjusted PIP screen.

Further, the present invention provides a method of controlling a display of a digital television, wherein a PIP screen is divided into sections each having pixels, the number of which corresponds to a W×H pixel size, and a predetermined bit value assigned to each pixel is adjusted, thus implementing a PIP screen having a desired shape.

Preferably, each pixel may be assigned an alpha value, so that a blending level is adjusted.

Preferably, the bit value may be expressed in at least 2 bits.

Preferably, the alpha value may be one selected from 0 to 255.

In addition, the present invention provides an apparatus for controlling a display of a digital television, comprising a main scaler for receiving main video data and adjusting a size of a main screen; a PIP scaler for receiving Picture-In-Picture (PIP) video data and adjusting a size of a PIP screen; alpha map memory for storing shapes of the PIP screen; and an alpha map screen mixing unit for receiving the main screen adjusted by the main scaler and the PIP screen adjusted by the PIP scaler and mixing the PIP screen with the main screen according to a screen shape transmitted from the alpha map memory.

Preferably, the shapes of the PIP screen stored in the alpha map memory may have the same size as that of the PIP screen transmitted from the PIP scaler.

### BRIEF DESCRIPTION OF THE DRAWINGS

FIG. 1 is a block diagram of a system for generating a Picture-In-Picture (PIP) screen in a conventional digital television;

FIG. 2 is a view showing examples of the configuration of a PIP screen and a POP screen;

FIG. 3 is a block diagram of an apparatus for controlling the display of a digital television according to an embodiment of the present invention;

FIGS. 4a and 4b are views showing examples of a PIP screen using an alpha map according to embodiments of the present invention; and

FIGS. 5a and 5b are views showing pixel values to implement alpha maps according to embodiments of the present invention.

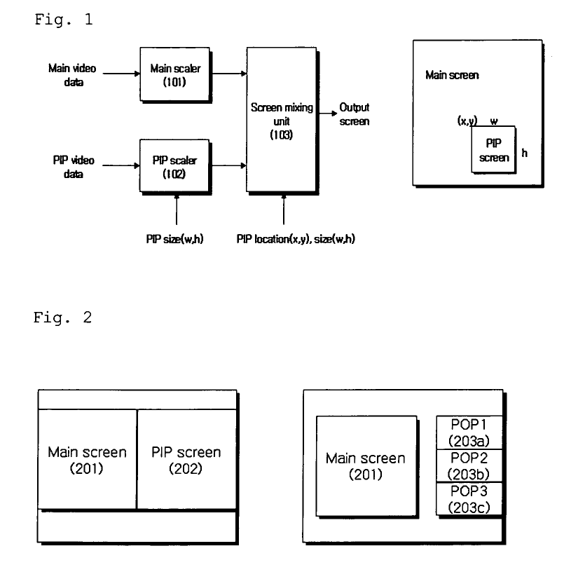

### DESCRIPTION OF THE PREFERRED EMBODIMENTS

Hereinafter, embodiments of the present invention will be described in detail with reference to the attached drawings. Reference now should be made to the drawings, in which the same reference numerals are used throughout the different drawings to designate the same or similar components. Further, in the following description of the present invention, detailed descriptions may be omitted if it is determined that the detailed descriptions of related well-known functions and construction may make the gist of the present invention unclear.

FIG. 3 is a block diagram of an apparatus for controlling the display of a digital television according to an embodiment of the present invention.

In the embodiment, the apparatus for controlling the display of a digital television includes a main scaler 101, a PIP scaler 102, memory 303 having alpha maps stored therein, and an alpha map screen mixer 302.

The embodiment schematically shows an apparatus for mixing a PIP screen with a main screen.

Referring to FIG. 3, main video data are input to the main scaler 101, and PIP video data are input to the PIP scaler 102.

The main scaler 101 adjusts the size of a main screen using the input main video data. A method of adjusting the size of the main screen can be variously realized according to the ability of those skilled in the art, but it is preferable to realize the method in the present invention by adjusting the resolution of the main screen.

The PIP video data are input to the PIP scaler 102, which also adjusts the resolution of the PIP video data according to the size of the PIP screen set by the user. In the present invention, the PIP screen adjusted by the PIP scaler 102 preferably has a resolution of (w, h), where each of w and h represents the number of pixels.

The memory 301 stores therein a plurality of PIP maps for a variety of screen shapes to adjust the shape of the PIP screen. It is apparent to those skilled in the art that the shape of the PIP screen can be variously implemented. It is preferable that the memory not only store the alpha maps, but also control the blending level of the alpha maps. A method of forming the alpha maps and a blending method will be described later in detail with reference to the drawings.

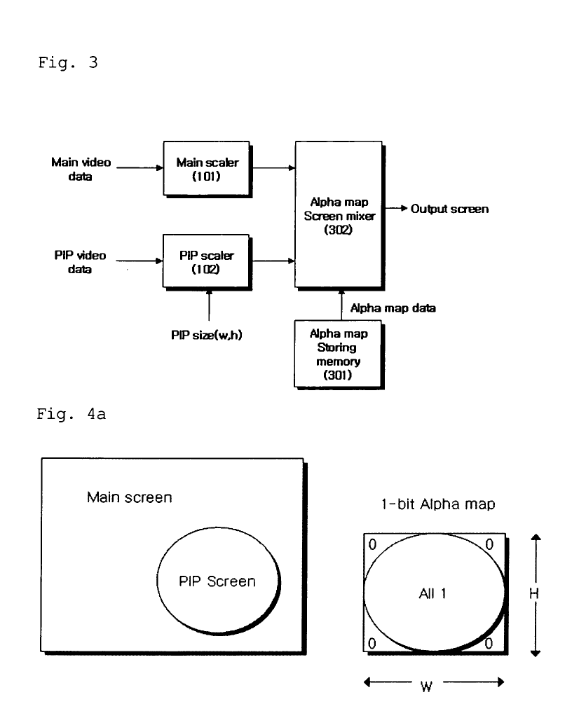

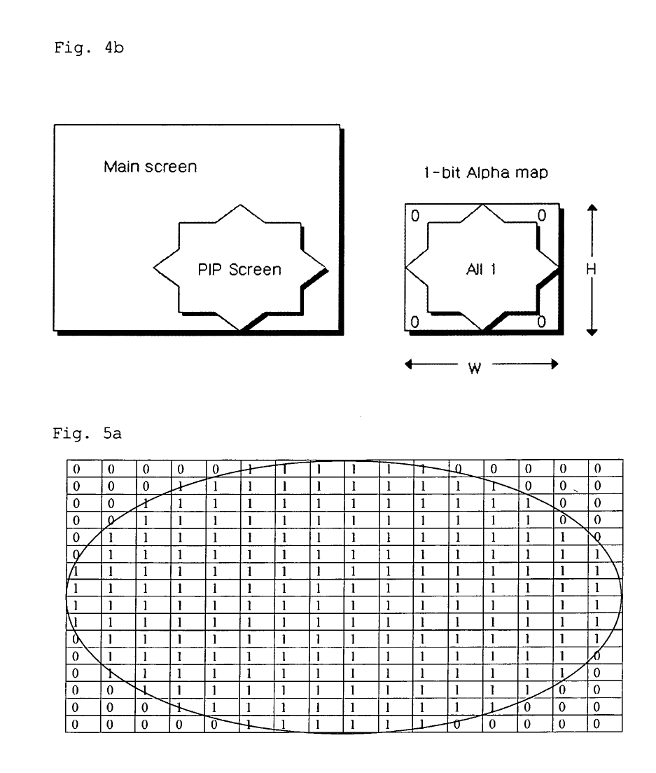

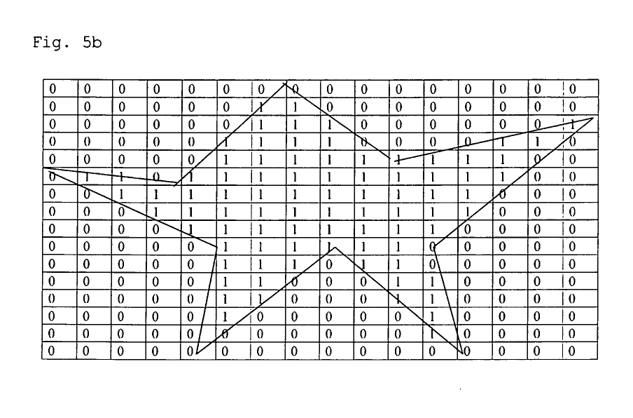

FIGS. 4a and 4b and FIGS. 5a and 5b are views showing a method of configuring PIP screens and a method of adjusting a blending level according to embodiments of the present invention.

In the embodiments, an alpha map used to configure a PIP screen is preferably implemented in a circular shape or star shape. Further, a case using a single alpha value and a case using an alpha map are separately described.

In the case where a single alpha value is provided as 1 bit, ON/OFF control between two screens can be performed. If the alpha value is 1, a PIP screen is displayed, while if the alpha value is 0, only a background screen is displayed, thus enabling switching between two screens to be performed. This method is used in the prior art, which is described above.

The present invention implements the single alpha value with a plurality of bits, such as 2, 4 or 8. In this case, a blending value between two screens can be designated. As an example of an 8-bit alpha value, a blending value can be calculated in the form of (alpha value*pixel value of screen #1+(255-alpha value)*pixel value of screen #2)/256. If the PIP screen is switched on, an effect of causing the PIP screen to be gradually bright and extended can be obtained when the alpha value is gradually changed from a minimum to a maximum. In the contrary case, a PIP screen that gradually disappears can be implemented.

FIGS. 4a and 4b are views showing examples of a method of implementing the shape of a PIP screen using an alpha map according to embodiments of the present invention.

In the embodiments, a PIP screen is implemented in a circular or star shape.

Referring to FIGS. 4a and 4b, the shape of a PIP screen can be freely adjusted when an alpha map composed of 1-bit alpha values is used.

FIG. 4a illustrates an example of using a W×H-bit binary alpha map corresponding to a PIP screen with a W×H pixel size, in which a circular PIP screen adjacent to a rectangle having a size of W×H is implemented. If the alpha values of all pixels constituting the inside of the circle are set to 1, and the alpha values of pixels existing outside of the circle are set to 0, the circular PIP screen is obtained.

FIG. 4b illustrates an example of using a W×H-bit binary alpha map corresponding to a PIP screen having a W×H pixel size, in which an eight pointed star PIP screen adjacent to a rectangle having a size of W×H is implemented. Similar to FIG. 4a, if the alpha values of all pixels constituting the inside of the eight pointed star are set to 1, and the alpha values of pixels existing outside of the star are set to 0, the eight pointed star PIP screen is obtained.

FIGS. 5a and 5b are views showing the configuration of alpha maps formed in FIGS. 4a and 4b. If the size of a basic PIP screen is set to satisfy width (W)=16 pixels and height (H)=16 pixels, an alpha map composed of several bits, in which one bit is assigned to each pixel, is stored to have a value of 1 in pixels that are included in a PIP screen, and a value of 0 in pixels that are not included in the PIP screen.

When a display screen including a PIP screen is created, the alpha map, constructed as described above, is also read from the memory, together with the data of a main screen (window) and the data of a PIP screen (window), so that the display screen is created using the results of a switching operation on the basis of the alpha map information with respect to individual pixels in the PIP screen.

The above process can be executed by the following operation:
if (alpha map = ‘0’) then
   output pixel = pixel of main window
else
   output pixel = pixel of PIP window
end if;

The above-described embodiments exemplify cases using 1-bit alpha values, but each alpha value can be extended to a plurality of bits. That is, when an alpha map composed of alpha values each having a plurality of bits, such as 2, 4 or 8 bits, is used, even a blending level with a main screen can be adjusted to a desired level in addition to the shape of a PIP screen. For example, if it is assumed that a pixel value at coordinates (x, y) on a main screen is M(x, y), a pixel value at the same location on a PIP screen is P(x, y) and an 8-bit blending value at the same location is B(x, y), an output pixel value O(x, y) generated as a blending result can be obtained by the following equation.
O(x,y)=(M(x,y)×(255−B(x,y))+P(x,y)×B(x,y))/255

If B(x, y) is 255, an ON effect is obtained as in the case of 1 in a binary alpha map, while if B(x, y) is 0, an OFF effect is obtained as in the case of 0 in a binary alpha map.

As described above, the present invention provides a method and apparatus for controlling the display of a digital television, which can arbitrarily adjust the display shape of an output screen and a blending level using a single alpha value or an alpha map in the digital television, thus configuring visually effective screens.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of controlling a display of a digital television, wherein:
a single alpha value is assigned to each of pixels constituting a Picture-In-Picture (PIP) screen, so that the single alpha value is set to a desired value, thus adjusting a blending level of the PIP screen and displaying the blending level-adjusted PIP screen.

2. A method of controlling a display of a digital television, wherein:
a PIP screen is divided into sections each having pixels, the number of which corresponds to a W×H pixel size, and a predetermined bit value assigned to each pixel is adjusted, thus implementing a PIP screen having a desired shape.

3. The display control method according to claim 2, wherein each pixel is assigned an alpha value, so that a blending level is adjusted.

4. The display control method according to claim 1 or 2, wherein the bit value is expressed in at least 2 bits.

5. The display control method according to claim 1 or 3, wherein the alpha value is one selected from 0 to 255.

6. An apparatus for controlling a display of a digital television, comprising:
a main scaler for receiving main video data and adjusting a size of a main screen;
a PIP scaler for receiving Picture-In-Picture (PIP) video data and adjusting a size of a PIP screen;
alpha map memory for storing shapes of the PIP screen; and
an alpha map screen mixing unit for receiving the main screen adjusted by the main scaler and the PIP screen adjusted by the PIP scaler and mixing the PIP screen with the main screen according to a screen shape transmitted from the alpha map memory.

7. The display control apparatus according to claim 6, wherein the shapes of the PIP screen stored in the alpha map memory have the same size as that of the PIP screen transmitted from the PIP scaler.
